(19) United States
(12) Patent Application Publication
(10) Pub. No.: US 2026/0087124 A1
(43) Pub. Date: Mar. 26, 2026

(54) TRUSTED PLATFORM MODULE GENERATED IN AN ISOLATED REGION OF A COMPUTING SYSTEM

(71) Applicant: Microsoft Technology Licensing, LLC, Redmond, WA (US)

(72) Inventors: Pushkar Vijay CHITNIS, Bothell, WA (US); Michael Anthony McREYNOLDS, Seattle, WA (US); David Kimler ALTOBELLI, Redmond, WA (US); Gangadhara Swamy Shivaganga NAGARAJU, Kirkland, WA (US); Michael Bishop EBERSOL, Woodinville, WA (US)

(21) Appl. No.: 18/896,507

(22) Filed: Sep. 25, 2024

(51) Int. Cl. G06F 21/54; G06F 21/57; G06F 21/64

(52) U.S. Cl. CPC G06F 21/54; G06F 21/575; G06F 21/64

(57) ABSTRACT

Systems, methods, and computer readable storage media described herein provide techniques for generating a virtual trusted platform module (vTPM) in an isolated region of a computing system. In an aspect, guest firmware of a virtual machine (VM) executing on device determines a state based on a configuration of the guest firmware. The guest firmware generates a vTPM based on the state and causes the vTPM to perform a cryptographic operation. In an aspect, the state is determined independent of state information external to the VM. In another aspect, the cryptographic operation includes unsealing a state of an operating system of the VM. The unsealed state is utilized to securely boot the operating system. In another aspect, the cryptographic operation includes sealing a state of an application hosted by the operating system. In another aspect, the VM is a confidential VM that isolates the vTPM from other services of the VM.

### BACKGROUND

Computing devices can be used to host instances of virtual machines. For instance, a host computing device may host a “guest” virtual machine instance. The host computing device and the guest virtual machine instance may or may not be managed by different entities (e.g., different users and/or organizations). The entity associated with the guest virtual machine may set various policies that restrict the type of device that may host the guest virtual machine. When the virtual machine instance is installed on the host computing device, secrets and/or keys associated with the virtual machine instance (e.g., the entity's secrets and/or keys) may be exposed to the host computing device and/or other services executing thereon.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments are described herein for providing virtual trusted platform modules (vTPMs) that are tied to a state of guest firmware. In an aspect, a guest firmware determines a first state based on its configuration. In some aspects, the first state (also referred to as a “first guest state”) is determined independent of state information external to the guest firmware. The guest firmware generates a vTPM based on the first state. In this context, the vTPM has a trust dependency on the guest firmware (e.g., and not another entity, such as a key management service or a service provider system). In a further aspect, the guest firmware causes the vTPM to perform cryptographic operations.

In a further aspect, the vTPM is generated in an isolated region of memory associated with the virtual machine. The isolated region prevents unauthorized access to the first state.

In a further aspect, a boot software utilizes the vTPM to unseal a sealed operating system state of a virtual machine (VM). The unsealed version of the operating system state is utilized to securely boot the VM.

In a further aspect, the vTPM is utilized to seal and/or unseal states of applications executed by a VM.

In a further aspect, the vTPM comprises a signed certificate attesting to a version and/or a configuration of the guest firmware.

In a further aspect, the vTPM receives an audit request from an entity and provides the signed certificate to the entity. The entity verifies the version and/or configuration of the guest firmware in the certificate matches a current version and/or configuration of the guest firmware.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of a system for generating and utilizing a vTPM in an isolated region of a computing system, in accordance with an embodiment.

FIG. 2 shows a block diagram of a host computing device that hosts a virtual machine comprising a vTPM generated in a guest firmware, in accordance with an embodiment.

FIG. 3 shows a flowchart of a process for generating and utilizing a vTPM in a guest firmware, in accordance with an embodiment.

FIG. 4 shows a flowchart of a process for utilizing a vTPM generated in a guest firmware to perform a cryptographic operation, in accordance with an embodiment.

FIG. 5 shows a flowchart of a process for generating a vTPM in a rebooted guest firmware, in accordance with an embodiment.

FIG. 6 shows a block diagram of a system for auditing a guest firmware or a vTPM, in accordance with an embodiment.

FIG. 7 shows a flowchart of a process for auditing a guest firmware or a vTPM, in accordance with an embodiment.

FIG. 8 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Embodiments for Virtual Trusted Platform Modules Generated in an Isolated Region of a Computing System

Computing devices can be used to host instances of virtual machines (VMs). For instance, a host computing device in an implementation can be configured to host one or more “guest” VM instances. The host computing device executes a VM manager configured to (e.g., utilizing a hypervisor) create, manage, and/or otherwise support the VM instances. The VM manager can interact directly with the hardware components of the host computing device. Alternatively, the VM manager is hosted by a host operating system deployed to interact with the hardware components of the host computing device.

In implementations of host computing devices, the VM instance and the host computing device are managed by (or owned by or used by or otherwise associated with) different entities. For instance, as a non-limiting example, a host computing device is managed by a service provider (e.g., a cloud service provider, an enterprise service provider, etc.) that provides resources (e.g., host computing devices and/or other hardware and associated software or firmware) to a customer entity. In this example, the VM instance is associated with another entity, e.g., a user entity (e.g., a customer of the service provider, a family user, a group of users, etc.), an organization entity (e.g., a customer organization of the service provider, a tenant of the service provider, a group of organizations, etc.), a computing service (e.g., an application or service acting on behalf of another entity), and/or another type of entity, as would be understood by a person ordinarily skilled in the relevant art(s) having benefit of this disclosure.

In some implementations, such as in confidential computing applications, the entity associated with the VM instance desires the VM instance to be deployed by a host computing device that satisfies certain policies. In some implementations, a virtual trusted platform module (vTPM) is used to evaluate if a destination system satisfies the required policies. The vTPM provides a tamper-resistant platform for performing security functions utilizing private keys known (e.g., only) to the vTPM (e.g., keys generated by the vTPM, keys securely stored by the vTPM, etc.). In some implementations, a vTPM is generated from a cloud-source state. Examples of cloud-source states include, for example, state information from a key vault (e.g., a key stored in a key vault, a kernel stored in a key vault, or ingredients for generating a key stored in a key vault), state information from a service provider (e.g., a security domain of the service provider, a service-provider-defined region, or a configuration of the service provider), and/or other state information external to the VM instance. In implementations, cloud-source states persist across shutdowns and/or reboots of the VM instance.

Embodiments described herein provide techniques for generating a vTPM in an isolated region of a computing system. In this context, an isolated region of a computing system is a region of memory of a guest (e.g., a confidential VM instance) hosted by a host computing system that prevents unauthorized access. Examples of such an isolated region include, but are not limited to, an isolated portion of guest firmware of the guest, an isolated portion of a boot manager of the guest, a portion of the guest dedicated to operating a vTPM, and/or the like. In embodiments, the vTPM is generated from a state of the guest firmware (e.g., independent of state information external to the guest firmware (e.g., cloud-source state)). In particular, embodiments utilize guest firmware of a guest (e.g., a VM instance) to determine a state of guest firmware. The vTPM is generated based on the determined state. Once generated, the vTPM is utilized to perform cryptographic operations for the guest. Examples of cryptographic operations include, but are not limited to, scaling an object, unsealing an object, signing an object, verifying a signature, encrypting an object, decrypting an object, and/or any other type of operation performed in a cryptographic manner on behalf of the guest. Examples of objects include, but are not limited to, a state of an operating system of a VM, a firmware state of the VM, a cryptographic key (e.g., a cryptographic key generated by the vTPM or a cryptographic key otherwise protected by a security function of the vTPM), data, encrypted versions of data, applications, application states. For instance, in accordance with an embodiment, the vTPM is utilized to seal or encrypt an object to the vTPM. As the vTPM is generated from a state of the guest firmware of the particular VM instance, encrypting or sealing to the vTPM binds the object to the particular VM instance. Furthermore, if the VM instance is rebooted or shut down, the state of the guest firmware changes. In this context, a new vTPM is generated by the guest firmware on the rebooted VM instance. The new vTPM is unable to unseal/decrypt objects sealed/encrypted by the original vTPM. In this context, the vTPM generated in the guest firmware is referred to as an “ephemeral” vTPM, as the vTPM state (e.g., only) persists until the guest is reset or shut down (or the vTPM is otherwise shut down or reset). Such embodiments improve security of the computer system the vTPM is implemented in by reducing or preventing access to objects protected by the vTPM. For instance, if an attacker attempts to reboot a VM instance in an attempt to gain control of the vTPM, even if the attacker has control of a new vTPM instance, they are unable to access objects protected by the original vTPM (e.g., even if the host computing device remains the same, the guest firmware version is the same, a configuration of the guest firmware is the same, and/or the new VM instance is a new instance of the same VM as the original VM instance).

As noted above, embodiments described herein provide and/or utilize a vTPM that binds objects to the particular instance of the vTPM. In this context, the vTPM enforces a “security domain” to which keys and secrets are bound to. Since the vTPM is generated from the guest firmware state, the security domain is specific to the instance of the guest firmware of the guest instance. In some embodiments, the state is masked from the host environment and from the service provider environment. In this context, security of the vTPM is further improved as the trust domain (e.g., the entities in which a user or application has to trust for cryptographic operations) is the vTPM itself, and independent of the host system or service provider. Furthermore, a user (or an application) is able to audit authenticity of the guest firmware based on measurements of the vTPM and/or information handled by the vTPM (e.g., a signature of guest firmware) without having to audit the host system or service provider, thereby reducing the time and/or compute resources expended to audit security of the vTPM.

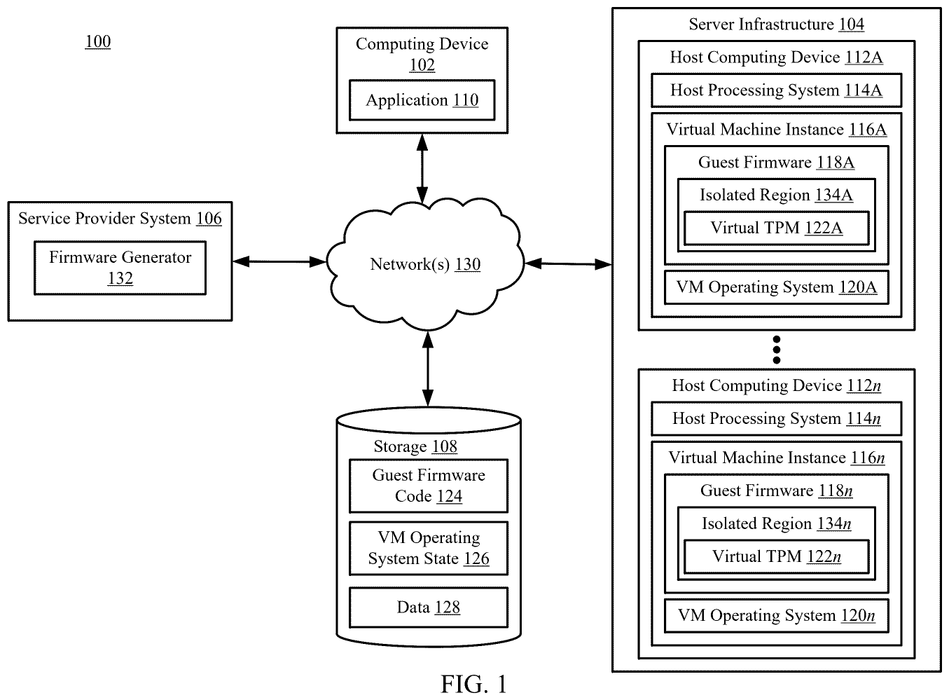

To help illustrate the aforementioned embodiments, FIG. 1 will now be described. In particular, FIG. 1 shows a block diagram of a system 100 for generating and utilizing a vTPM in an isolated region of a computing system, in accordance with an embodiment. As shown in FIG. 1, system 100 includes a computing device 102, a server infrastructure 104, a service provider system 106, and storage 108. Each of computing device 102, server infrastructure 104, service provider system 106, and storage 108 are communicatively coupled via a network 130. Network 130 may comprise one or more networks such as local area networks (LANs), wide area networks (WANs), enterprise networks, the Internet, etc., and may include one or more of wired and/or wireless portions.

Storage 108 comprises a database, a data store, one or more memory devices and/or the like for storing data. For example, as shown in FIG. 1, storage 108 stores guest firmware code 124, VM operating system states 126 (referred to as “VM operating system states 126” herein), and data 128. In accordance with an embodiment, guest firmware code 124 is stored as a signed version of firmware code and/or a signed configuration of firmware code. In accordance with an embodiment, data 128 is encrypted or unencrypted data. In accordance with an embodiment, storage 108 stores (e.g., sealed or unsealed) states of applications executable by VM instances hosted by host computing devices of server infrastructure 104, as described elsewhere herein. As shown in FIG. 1, storage 108 is external to computing device 102, server infrastructure 104, and service provider system 106. In an alternative embodiment, all or a portion of storage 108 is internal to computing device 102, a computing device of server infrastructure 104, and/or a computing device of service provider system 106. In accordance with an embodiment, storage 108 is a remote storage accessible over network 130 (e.g., a web storage, a blob storage, a networked file system, a cloud storage, and/or the like).

Computing device 102 is any type of stationary or mobile processing device, including, but not limited to, a desktop computer, a server, a mobile or handheld device (e.g., a tablet, a personal data assistant (PDA), a smart phone, a laptop, etc.), an Internet-of-Things (IoT) device, etc. In accordance with an embodiment, computing device 102 is associated with a user (e.g., an individual user, a group of users, an organization, a family user, a customer user, an employee user, an admin user (e.g., a service team user, a developer user, a management user, etc.), etc.). Computing device 102 accesses host computing devices of server infrastructure 104 and/or applications executed by the host computing devices, as described elsewhere herein. Computing device 102 stores data and executes computer programs, applications, and/or services. For instance, as shown in FIG. 1, computing device 102 executes an application 110. In accordance with an embodiment, and as described elsewhere herein, application 110 enables a user to access and/or utilize VM instances hosted by server infrastructure 104 and/or access and/or utilize vTPMs of VM instances.

Server infrastructure 104 is a network-accessible server set (e.g., a cloud-based environment, an enterprise network server set, and/or the like). As shown in FIG. 1, server infrastructure 104 comprises host computing devices 112A-112n. In some embodiments, host computing devices 112A-112n form a cluster of host computing devices. Alternatively, subsets of host computing devices 112A-112n form separate clusters. In another alternative or additional embodiment, host computing devices 112A-112n includes one or more independent host computing devices. In an embodiment, each of host computing devices 112A-112n are any type of stationary or mobile processing device of server infrastructure 104 (e.g., a server or another type of computing device, as described elsewhere herein). In accordance with an embodiment, each of host computing devices 112A-112n comprises a host processing system and is configured to execute an instance of a VM (a “VM instance”). For example, as shown in FIG. 1, host computing device 112A comprises a host processing system 114A and is configured to execute a VM instance 116A and host computing device 112n comprises a host processing system 114n and is configured to execute a VM instance 116n. In accordance with an embodiment, the VM instance is stored in memory of the respective host computing device as program code executable by the respective host processing system. In accordance with an embodiment, VM instance 116A and/or VM instance 116n are confidential VMs (“CVMs”). In accordance with an embodiment, a user of computing device 102 (or application 110 on behalf of the user) accesses host computing device 112A and/or host computing device 112n to utilize VM instance 116A and/or VM instance 116n.

As noted above, a user or application may access host computing devices 112A-112n to utilize respective VM instances 116A-116n. Each of VM instances 116A-116n comprises a guest firmware and a VM operating system (also referred to as a “guest operating system”). For example, as shown in FIG. 1, VM instance 116A comprises a guest firmware 118A and a VM operating system 120A and VM instance 116n comprises a guest firmware 118n and a VM operating system 120n. Each of VM operating systems 120A and 120n are configured to execute applications (not shown in FIG. 1 for brevity). Guest firmware 118A and 118n are configured to assist in starting up respective VM instances 116A and 116n, respective VM operating systems 120A and 120n, generate vTPMs, utilize vTPMs, and/or cause utilization of vTPMs. While FIG. 1 illustrates only one VM instance on each of host computing devices 112A-112n, in an alternative embodiment, a host computing device hosts any number of VM instances (e.g., ones, tens, etc. of VM instances). Furthermore, not all VM instances need be associated with the same entity and/or user account.

As discussed above, guest firmware 118A and 118n are configured to generate and cause utilization of vTPMs. For instance, as shown in FIG. 1, guest firmware 118A generates a vTPM 122A in an isolated region 134A and guest firmware 118n generates a vTPM 122n in an isolated region 134n. In accordance with an embodiment, isolated region 134A and isolated region 134n are respective portions of guest firmware 118A and 118n that are protected from tampering or other unauthorized access In accordance with an embodiment, guest firmware 118A generates vTPM 122A based on a state of guest firmware 118A and independent of state information external to VM instance 116A and guest firmware 118n generates vTPM 122n based on a state of guest firmware 118n and independent of state information external to VM instance 116n. In this manner, a state of a respective vTPM is not exposed external to the respective guest firmware, thereby increasing security. Furthermore, in accordance with an embodiment, by generating a vTPM based on the guest firmware state and independent of external state information, the trust boundary is limited to the guest firmware and the vTPM.

In accordance with an embodiment, guest firmware 118A and/or guest firmware 118n cause respective vTPMs 122A and/or 122n to seal a respective guest firmware state to another security domain. For instance, suppose guest firmware 118A causes vTPM 122A to seal the state of guest firmware 118A to hardware of host computing device 112A. In this context, by sealing the state to an additional security domain, use of the respective vTPM for cryptographic operations is further tied to the additional security domain, thereby tying the security of the vTPM to the security of the security domain and its lifetime to the availability of keys associated with the security domain.

As shown in FIG. 1, vTPM 122A and vTPM 122n are guest vTPMs of respective VM instances 116A and 116n. In an alternative embodiment, any of vTPM 122A and/or 122n are implemented as a vTPM of a confidential deployment environment that deploys VM instances in the respective host computing device. vTPMs 122A and 122n provide tamper-resistant platforms for performing security functions on behalf of respective VM instances 116A and 116n. Examples of a security function include, but are not limited to, performing a cryptographic operation to modify an object, measuring a system integrity, creating a cryptographic key, and/or attesting authenticity of respective guest firmware. In an example embodiment, the object is associated with the respective VM instance, an application executed by the respective VM instance, and/or an operation the VM instance (or an application executed thereby or another component or subservice of the VM instance) is attempting to perform.

As described herein, vTPMs 122A and 122n are configured to generate keys configured to be utilized in attempts to perform cryptographic operations (e.g., to unseal and/or seal objects (e.g., to unseal or seal states of operating systems of VMs, to unseal or seal states of applications, etc.), to encrypt and/or decrypt objects, to sign or verify objects, and/or to perform any other cryptographic operation described herein). In accordance with an embodiment, vTPMs 122A and/or 122B are configured to generate a key from a respective vTPM state. In accordance with an embodiment, the vTPM state is determined based on the respective guest firmware state. Additional details regarding the generation of keys are described with respect to FIG. 4, as well as elsewhere herein.

In accordance with an embodiment, a vTPM utilizes the same key for multiple cryptographic operations (e.g., the same key (e.g., a decryption key) is used for unsealing and/or decrypting objects, the same key (e.g., an encryption key) is used for sealing and/or encrypting objects, etc.). In an alternative embodiment, separate keys are used for each cryptographic operation (e.g., a first decryption key is used for unsealing objects and a second decryption key is used for decrypting objects, a first encryption key is used for sealing objects and a second encryption key is used for encrypting objects, a signing key is used for signing objects, a verification key is used for verifying objects, and/or the like). Moreover, different keys may be used to perform a type of cryptographic operation with respect to a particular object (e.g., a first decryption key is used for unsealing an operating system state of a VM, a second decryption key is used for unsealing a state of a (e.g., particular) application, etc.).

As shown in FIG. 1, vTPM 122A is generated in isolated region 134A of guest firmware 118A and vTPM 122n is generated in isolated region 134n of guest firmware 118n. However, embodiments described herein are not so limited. For instance, in an alternative embodiment, vTPM 122A is generated in another isolated region of VM instance 116A. For example, suppose guest firmware 118A generates (or causes generation of) vTPM 122A in an isolated boot manager of VM instance 116A, not shown in FIG. 1 for brevity. In another example, suppose guest firmware 118A generates (or causes generation of) vTPM 122A in a portion of VM instance 116A configured for hosting vTPMs. In embodiments, the isolated region of VM instance 116A that vTPM 122A is generated in is an isolated and protected region of memory of host computing device 112A.

Service provider system 106 comprises one or more stationary or mobile processing devices (e.g., servers or other types of computing devices, as described elsewhere herein) associated with a service provider. As shown in FIG. 1, service provider system 106 executes a firmware generator 132. Firmware generator 132 is configured to generate guest firmware code of guests (e.g., VMs) executable in server infrastructure 104. For instance, in accordance with an embodiment, firmware generator 132 is configured to generate guest firmware code 124 and store it in storage 108. In accordance with an embodiment, guest firmware code 124 comprises program instructions structured to cause a processor to generate a vTPM based on a state of the instance of the guest firmware. For instance, suppose guest firmware code 124 is the firmware code for guest firmware 118A. In this context, guest firmware code 124 executed in VM instance 116A causes guest firmware 118A to begin setup of VM instance 116A, including generating vTPM 122A based on a state of guest firmware 118A. In embodiments, the state of the guest firmware is different for a particular instance of a guest firmware 118A. For example, if guest firmware 118A and guest firmware 118n utilize the same guest firmware code 124, the state of the guest firmware 118A is different from guest firmware 118n. Furthermore, if VM instance 116A reboots and a new instance of guest firmware 118A is executed, the state of the instance of guest firmware 118A is different from the first instance of guest firmware 118A. While only guest firmware code 124 is shown in FIG. 1, in an alternative embodiment, firmware generator 132 is utilized to generate code for multiple guest firmware.

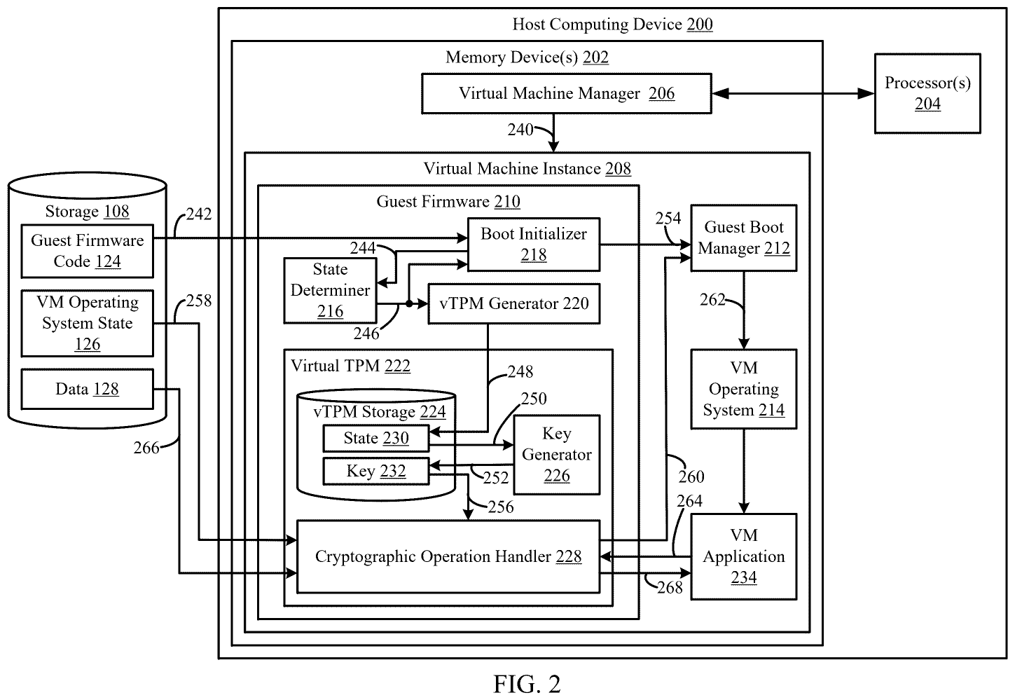

Host computing devices, such as host computing devices 112A and 112n of FIG. 1, are configurable in various ways to host VM instances and vTPMs, in embodiments. For instance, FIG. 2 shows a block diagram of a host computing device 200 that hosts a VM comprising a vTPM generated in a guest firmware, in accordance with an embodiment. FIG. 2 also depicts storage 108, as described with respect to FIG. 1. As shown in FIG. 2, host computing device 200 comprises one or more memory device(s) 202 (“memory 202” herein) and one or more processors 204 (“processor 204” herein). Memory 202 includes volatile storage portions such as random access memory (RAM) and/or persistent storage portions such as hard drives, non-volatile RAM, and/or the like, to store or to be configured to store computer program instructions/code. As shown in FIG. 2, memory 202 comprises a VM manager 206 and a VM instance 208 (“VM instance 208”). VM instance 208 is an example of VM instance 116A and/or 116n, as described with respect to FIG. 1. Processor 204 is an example of host processing system 114A and/or 114n, as described with respect to FIG. 1. Processor 204 comprises circuitry configured to execute computer instructions such as, but not limited to, embodiments of VM manager 206 and VM instance 208, including one or more sub-components or subservices thereof, which may be implemented as computer program instructions, as described herein.

In some embodiments, host computing device 200 includes additional hardware not shown in FIG. 2 for brevity and clarity. For instance, in an embodiment, host computing device 200 comprises one or more communication interfaces, a measurement device, a peripheral device, and/or any other hardware component of a host computing device. A communication interface is any type or number of wired and/or wireless communication or network adapters, modems, etc., configured to enable host computing device 200 to communicate intra-system with components thereof, as well as with other devices and/or systems over a network (e.g., over network 130). A measurement device is a device configured to measure hardware of host computing device 200 and/or firmware and/or software stored by memory 202. An example of a measurement device includes, but is not limited to, a hardware TPM.

As noted above, memory 202 stores VM manager 206 and VM instance 208. VM manager 206 is configured to create, manage, and/or otherwise support VM instances hosted by host computing device 200. As shown in FIG. 2, VM manager 206 interacts (e.g., directly) with processor 204 of host computing device 202. In an alternative embodiment, memory 202 stores a host operating system that interacts with hardware 204 and hosts VM manager 206 (e.g., as a subservice of the host operating system).

VM instance 208 is an instance of a VM hosted by host computing device 200. In accordance with an embodiment VM instance 208 is a confidential VM. As shown in FIG. 2, VM instance 208 comprises a guest firmware 210, a guest boot manager 212, a VM operating system 214, and a VM application 234, each of which are implemented as subservices (or sub-subservices) of VM instance 208. Guest firmware 210 is an example of guest firmware 118A and/or 118n and VM operating system 214 is an example of VM operating system 120A and/or 120n, as respectively described with respect to system 100 of FIG. 1. In accordance with an embodiment, guest firmware 210 is a host compatibility layer of VM instance 208. As further shown in FIG. 2, guest firmware 210 comprises a state determiner 216, a boot initializer 218, a vTPM generator 220, and a vTPM 222. In accordance with an embodiment, boot initializer 218 comprises guest boot manager 212. vTPM 222 is an example embodiment of vTPM 122A and/or 122n as described with respect to system 100 of FIG. 1. As shown in FIG. 2, vTPM 222 comprises a vTPM storage 224, a key generator 226, and a cryptographic operation handler 228. Key generator 226 and cryptographic operation handler 228 are sub-services of vTPM 222. In accordance with an embodiment, vTPM storage 222 represents a secure portion of memory 202 accessible to vTPM 222 (e.g., and not accessible to other services or subservices executing on host computing device 200). In this context, access to data stored in vTPM storage 224 is prevented except by (or through) vTPM 222.

As noted above, VM manager 206 creates, manages, and supports VMs hosted by host computing device 200. For instance, VM manager 206 creates and manages VM instance 208. In accordance with an embodiment, VM manager 206 utilizes a hypervisor (not shown in FIG. 2 for brevity) to create, manage, and/or otherwise support VM instance 208. As shown in FIG. 2, VM manager 206 launches VM instance 208 via launch operation 240. In accordance with an embodiment, VM manager 206 executes launch operation in response to a request received from an entity (e.g., a user (e.g., a user of computing device 102 of FIG. 1), an organization, an application executing on behalf of a user or organization (e.g., application 110), etc.), a computing device associated with an entity (e.g., computing device 102), and/or the like. In accordance with an embodiment, to create VM instance 208, VM manager 206 obtains guest firmware code 124 (e.g., stored in storage 108 or included in the request to launch the VM) and launch operation 240 includes instructions to initialize guest firmware 210 utilizing guest firmware code 124. Alternatively, and as shown in FIG. 2, launch 240 causes guest firmware 210 to initiate installation by obtaining guest firmware code 124 from storage 108 via code retrieval signal 242. In either context, boot initializer 218 of guest firmware 210 begins the installation of guest firmware 210 and VM instance 208.

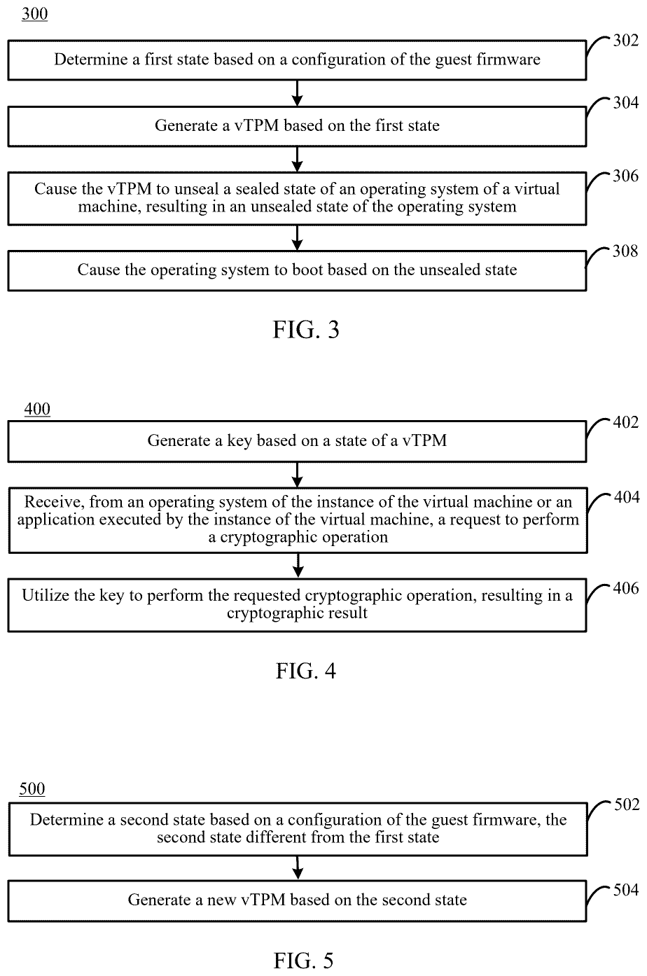

In embodiments, as part of initialization of guest firmware 210 or another operation of guest firmware 210, guest firmware 210 operates to generate vTPM 222. To better illustrate embodiments of generating and utilizing vTPM 222, and in particular with respect to booting VM instance 208, host computing device 200 is further described with respect to FIG. 3. FIG. 3 shows a flowchart 300 of a process for generating and utilizing a vTPM in a guest firmware, in accordance with an embodiment. In an embodiment, guest firmware 210 operates according to the steps of flowchart 300. Note that not all steps of flowchart 300 need be performed in all embodiments. Further structural and operational embodiments will be apparent to persons skilled in the relevant art(s) based on the following descriptions of FIGS. 2 and 3.

Flowchart 300 begins with step 302. In step 302, a first state is determined based on a configuration of the guest firmware. For example, state determiner 216 receives configuration information 244 from boot initializer 218 and determines a guest state 246 based on configuration information 244. In accordance with an embodiment, configuration information 244 comprises information with respect to the particular instance of guest firmware 210 instantiated in VM instance 208. Examples of configuration information 244 include, but are not limited to, a location in memory 202 that guest firmware 210 is installed in, a time at which installation of guest firmware 210 began, a version of guest firmware code 124, a configuration of guest firmware code 124, an identifier of the VM that guest firmware 210 corresponds to, and/or any other information associated with the particular instance of guest firmware 210. In accordance with an embodiment, state determiner 216 determines guest state 246 independent of state information external to the guest firmware (e.g., a state of service provider system 106, a state of host computing device 200 (e.g., a state of host computing device 200 excluding guest firmware 210), a state of a key vault, a state of server infrastructure 104, a state of computing device 102, and/or a state of any other service and/or computing device external to guest firmware 210. In this context, guest state 246 is unique to the particular instance of guest firmware 210 and a trust boundary is isolated to guest firmware 210. In accordance with an embodiment, state determiner generates guest state 246 at runtime (e.g., as part of the initialization of guest firmware 210).

In step 304, a vTPM is generated based on the first state. For example, vTPM generator 220 receives guest state 246 and generates vTPM 222 based on guest state 246. In accordance with an embodiment, vTPM generator 220 generates vTPM 222 in an isolated region of memory device 202 associated with virtual machine instance 208, the isolated region preventing unauthorized access to a state of vTPM 222. In accordance with an embodiment, vTPM generator 220 generates vTPM 222 by generating vTPM state 230 and causing vTPM state 230 to be stored in vTPM storage 224 via storage signal 248. In accordance with an embodiment, vTPM state 230 is a root key (also referred to as an “endorsement” key) of vTPM 222. In this context, vTPM generator 220 generates vTPM state 230 utilizing an (e.g., cryptographic) key generation algorithm to generate the key based on guest state 246. In accordance with another embodiment, vTPM state 230 is a “key ingredient.” In this context, key generator 226 generates an endorsement key from vTPM state 230 and, optionally, stores the endorsement key in vTPM storage 224. Since vTPM state 230 is generated in guest firmware 210 independent of external state information and otherwise not exposed external to VM instance 208 (e.g., to VM manager 206, to processor 204, or to other software and/or hardware of host computing device 200), the trust dependency of vTPM 222 is limited to guest firmware 210 and vTPM 222. Furthermore, in accordance with an embodiment, vTPM state 230 is securely generated and stored to prevent sub-services of VM instance 208 (e.g., other than guest firmware 210) from accessing unencrypted versions of (e.g., “in-the-clear” versions of) vTPM state 230. In accordance with an embodiment, vTPM generator 220 assigns separate privileges (e.g., utilizing a VM privilege level) to vTPM 222 in a manner that isolates (e.g., prevents unauthorized access to) vTPM state 230 and memory of vTPM 222 from memory accessible to other services of VM instance 208 (e.g., VM operating systems, VM applications, and/or the like).

In accordance with an embodiment, subsequent to generation, key generator 226 generates keys for use in cryptographic operations. For instance, in accordance with an embodiment shown in FIG. 2, key generator 226 obtains vTPM state 230 via state signal 250 and generates key 232 based on vTPM state 230. In accordance with an embodiment, key 232 is a symmetrical cryptographic key (e.g., a key configured for decryption and encryption, a key configured for unsealing and sealing, a key configured for signing and verifying, and/or the like). In an alternative embodiment, key 232 is an asymmetric key pair comprising a first key (e.g., a key configured for encryption, a key configured for scaling, a key configured for verifying, and/or the like) and a second key (e.g., a key configured for decryption, a key configured for unsealing, a key configured for signing, and/or the like). As also shown in FIG. 2, key generator 226 stores key 232 in vTPM storage 224 via storage signal 252. Additional details regarding key generation are described with respect to FIG. 4, as well as elsewhere herein.

In step 306, the vTPM is caused to unseal a sealed state of an operating system of a virtual machine, resulting in an unsealed state of the operating system. For example, vTPM 222 is caused to unseal a sealed version of VM operating system state 126. Depending on the implementation, guest firmware 210, guest boot manager 212, and/or another component of VM instance 208 utilizes vTPM 222 to unseal the sealed version of VM operating system state 126. For instance, in accordance with an embodiment, guest boot manager 212 is a unified extensible firmware interface (UEFI) that utilizes vTPM 222 to unseal the scaled version of VM operating system state 126. In accordance with an embodiment, cryptographic operation handler 228 of vTPM 222 utilizes a key (e.g., key 232) to unseal the sealed version of VM operating system state 126.

vTPM 222 is caused to unseal sealed versions of VM operating system state 126 in various scenarios, in embodiments. As a non-limiting example, suppose VM operating system state 126 is stored as a sealed version in storage 108. Further suppose VM operating system state 126 is sealed based on a security policy that restricts the system that VM operating system 214 is able to be launched in. In this context, vTPM 222 is utilized to verify host computing device 200, a component of host computing device 200 (e.g., memory 202, processor 204, etc.), a service executing on host computing device 200 (e.g., VM manager 206, VM instance 208, etc.), a sub-service of VM instance 208, and/or guest firmware 210 are in compliance with a security policy. For instance, suppose vTPM 222, during an initial boot process, measures hardware, firmware, and/or software of host computing device 200 and/or VM instance 208 and stores the measurements (e.g., in vTPM storage 224). In this context, vTPM 222 determines the measurements satisfy a security policy that protects VM operating system state 126. When it is time to boot VM operating system 214 based on VM operating system state 126 (e.g., responsive to a request for a verified unsealed version of the operating system state (not shown in FIG. 2) from guest boot manager 212), cryptographic operation handler 228 obtains the sealed version of VM operating system state 126 via an operating system state signal 258 and re-measures the hardware, firmware, and/or software measured during the initial boot process. If cryptographic operation handler 228 determines the measurements match the measurements made during the initial boot process, cryptographic handler 228 verifies the system satisfies the security policy and unseals the sealed version of VM operating system state 126, resulting in an unsealed version of VM operating system state 126. In this manner, vTPM 222 restricts access to unsealed versions of VM operating system state 126 unless the host system (and/or the VM instance) satisfies criterion of a security process that protects the state. In accordance with a further embodiment of this non-limiting example, vTPM 222 utilizes a key known only to vTPM 222 to store measurements made by vTPM 222 and utilizes a key securely provided to vTPM 222 to unseal the sealed version of VM operating system state 126 (e.g., a key corresponding to the key utilized to seal VM operating system state 126).

In another non-limiting example, suppose VM operating system state 126 is stored in as an unsealed version in storage 108 or is otherwise provided to vTPM 222 as an unsealed version (e.g., is unsealed utilizing a hardware TPM of host computing device 200, not shown in FIG. 2). In this context, cryptographic operation handler 228 receives VM operating system state 126 via operating system state signal 258 (or from VM manager 206 on behalf of a hardware TPM, or from a persistent virtual TPM of VM instance 208). In this example, cryptographic operation handler 228 measures and binds VM operating system state 126 to vTPM 222. Further suppose vTPM 222 generates a sealed version of VM operating system state 126 (e.g., utilizing key 232) and stores the sealed version in vTPM storage 224 (not shown in FIG. 2 for brevity). Alternatively, the sealed version is encrypted and stored external to vTPM 222 (e.g., in other storage of memory 202 or in storage 108). In a non-limiting example, suppose guest boot manager 212 fails to boot VM operating system state 126. In this example, cryptographic operation handler 228 utilizes key 232 (e.g., obtained via key signal 256) to unseal the sealed version of VM operating system state 126.

In step 308, the operating system is caused to boot based on the unsealed state. For example, cryptographic operation handler 228 provides the unsealed version of VM operating system state 126 to guest boot manager 212 via unsealed state signal 260. In this context, guest boot manager 212 (e.g., subsequent to receiving a boot signal 254 from boot initializer 218) boots VM operating system 214 based on the unsealed version of VM operating system state 126. By preventing booting VM operating system 214 until the operating system state is unsealed in this way, vTPM 222 improves computer security by reducing or preventing access to unsealed state 248 (which may enable access to an entity's secrets) on unauthorized hardware, in an unauthorized region, in an unauthorized VM instance, and/or in an otherwise unauthorized system. As shown in FIG. 2, guest boot manager 212 boots VM operating system 214 via boot action 262. In accordance with an embodiment, vTPM 222 measures VM operating system 214 (e.g., during the boot process, subsequent to the boot process, and/or the like). In this context, vTPM 222 is able to remeasure VM operating system 214 and verify VM operating system 214 based on the original measurements and remeasurements.

As also shown in FIG. 2, and as stated above, VM instance 208 comprises VM application 234. In accordance with an embodiment, VM application 234 is an application hosted and/or otherwise managed by VM operating system 214. In accordance with an embodiment, vTPM 222 measures VM application 234 and verifies measurements of VM application 234. In accordance with another embodiment, vTPM 222 seals a state of VM application 234. In this context, if VM application 234 is stopped and is to be restarted (e.g., without restarting VM instance 208), vTPM 222 provides an unsealed state of VM application 234 to VM operating system 214 to cause VM operating system 214 to relaunch VM application 234 from the unsealed state.

In embodiments, vTPMs such as vTPM 222 of FIG. 2 perform cryptographic operations on behalf of a VM instance and/or subservices thereof. VTPM 222 operates in various ways to perform cryptographic operations, in embodiments. For example, FIG. 4 shows a flowchart 400 of a process for causing a vTPM generated in a guest firmware to perform a cryptographic operation, in accordance with an embodiment. In an embodiment, vTPM 222 operates according to the steps of flowchart 400. Note that not all steps of flowchart 400 need be performed in all embodiments. Further structural and operational embodiments will be apparent to persons skilled in the relevant art(s) based on the following description of FIG. 4 with respect to FIG. 2.

Flowchart 400 begins with step 402. In step 402, a key is generated based on a state of a vTPM. For example, key generator 226 of FIG. 2 receives vTPM state 230 and generates key 232 based on vTPM state 230. In this context, key 232 is bound to vTPM 222 and, depending on the implementation, is configured to decrypt, encrypt, unseal, seal, sign, verify, and/or perform other cryptographic operations with respect to vTPM 222. For instance, in an example embodiment, if key 232 is utilized to encrypt or seal an object, the resulting modified object is bound to vTPM 222 in a manner that prevents other services and/or hardware from accessing an unencrypted or unsealed version of the object. In some embodiments, key generator 226 generates a key that further restricts an object or operation (e.g., restricts it to vTPM 222 and an application (e.g., VM application 234), restricts it to vTPM 222 and an operating system (e.g., VM operating system 214), restricts it to vTPM 222 and particular hardware of host computing device 200, and/or the like). In this context, if the component and/or service (or subservice) the key is further restricted to changes, access to unencrypted or unsealed versions is prevented.

In step 404, a request to perform a cryptographic operation is received from an operating system of the VM instance or an application executed by the VM instance. For example, as shown in FIG. 2, cryptographic operation handler 228 receives a request 264 from VM application 234. Request 264 is a request to perform a cryptographic operation. Example requests to perform cryptographic operations on behalf of an application include, but are not limited to, a request to seal a state of the application (e.g., if the application is to restart, in case the application restarts, etc.), a request to decrypt an object on behalf of the application, a request to encrypt an object on behalf of the application, a request to verify a signature for the application, a request to sign an object for the application, a request to seal or unseal an object to the application, a request to store a data object on behalf of the application, a request to verify measurements, and/or the like. For instance, in accordance with an embodiment, request 264 is a request to perform a cryptographic operation with respect to an object utilizing a key (e.g., key 232). In an implementation, request 264 (or a concurrent or subsequent request) comprises the object to be modified by the cryptographic operation. Alternatively, request 264 comprises a reference to the object to be modified (e.g., an identifier that uniquely identifies the object, a location in a data store in which the object is stored, and/or the like). For instance, as a non-limiting example described with respect to FIG. 2, suppose the object is a data object 266 of data 128. In this context, cryptographic operation handler 228 receives or otherwise obtains data object 266 from storage 108. In accordance with an embodiment, request 264 indicates the type of cryptographic operation to be performed. In accordance with another embodiment, request 264 indicates whether to bind data object 266 (e.g., by sealing or by encrypting) to vTPM 222 or to vTPM 222 and an additional restriction. For instance, in accordance with an embodiment, request 264 indicates data object 266 is to be bound to vTPM 222 and VM application 234.

In step 406, the key is utilized to perform the requested cryptographic operation, resulting in a cryptographic result. For example, cryptographic operation handler 228 utilizes key 232 to perform the cryptographic operation requested in request 264, resulting in a cryptographic result. For instance, with respect to the example described with respect to data object 266 and step 404, cryptographic operation handler 228 utilizes key 232 to perform the requested cryptographic operation to modify data object 266, resulting in a modified version of data object 266. In accordance with an embodiment, the cryptographic result is provided to VM application 234 via a response 268. For example, suppose request 264 is a request to release an encrypted version of data object 266 to VM application 234. In this context, cryptographic operation handler 238 (e.g., subsequent to verifying measurements of VM application 234) utilizes key 232 to decrypt the encrypted version of data object 266 and provides the decrypted version to VM application 234 in response 268. Alternatively, the cryptographic result is stored by vTPM 222 or on behalf of vTPM 222 (e.g., in a secure manner). For instance, suppose request 264 is a request to securely store a data object included in request 264. In this context, cryptographic operation handler 238 encrypts the included data object (or seals the included data object to VM application 234) utilizing key 232, resulting in an encrypted (or sealed) version of the data object. In a further embodiment, vTPM 222 caches the encrypted (or sealed) version for later retrieval. In a further embodiment where cryptographic operation handler 228 sealed the data object to VM application 234, vTPM 222 measures VM application 234 when (or prior to) scaling the data object and prevents access to an unsealed version of the data object except by a VM application with measurements that match those taken when (or prior to) sealing the data object.

Flowchart 400 of FIG. 4 has been described with respect to cryptographic operation handler 228 receiving a request to perform a cryptographic operation from an application, such as VM application 234. However, it is also contemplated herein that cryptographic operation handler 228 performs cryptographic operation on behalf of other subservices of VM instance 208. For example, as recited in step 404 of flowchart 400, cryptographic operation handler 228 receives a request to perform a cryptographic operation from an operating system of the VM instance (e.g., VM operating system 214). Examples of a request to perform cryptographic operations on behalf of VM operating system 214 include, but are not limited to, a request to seal a state of an application hosted by VM operating system 214 (e.g., VM application 234), a request to unseal a state of an application hosted by VM operating system 214 (e.g., unsealing an application state previously scaled by cryptographic operation handler 228), a request to encrypt or decrypt data on behalf of VM operating system 214, a request to verify measurements of VM operating system 214 or an application hosted by VM operating system 214, a request to store data on behalf of VM operating system 214, and/or the like. For instance, in a non-limiting application state scaling example, VM operating system 214 requests that cryptographic operation handler 228 seals a state of VM application 234. In this context, cryptographic operation handler 228 measures VM operating system 214 (and, optionally, guest firmware 210 and/or hardware of host computing device 200) and binds the state of VM application 234 to the measurements. In an embodiment, to bind the state of VM application 234, key generator 226 generates a key based on the measurements (e.g., and vTPM state 230) and utilizes the key to seal the state of VM application 234. In an example, the sealed state is stored in vTPM storage 224. Alternatively, the sealed state is stored external to vTPM 222 in a manner that prevents an application or hardware from accessing the unsealed version of the state.

With continued reference to the non-limiting application state sealing example, suppose VM operating system 214 is to relaunch VM application 234 from the sealed state at a subsequent time. In this context, VM operating system 214 requests cryptographic operation handler 228 to unseal the sealed state of VM application 234. In an embodiment, to unseal the sealed state of VM application 234, cryptographic operation handler 228 re-measures VM operating system 214 (and any other hardware, software, or firmware that the sealed state is bound to) and verifies the measurements match the measurements used to seal the sealed state of VM application. In accordance with an embodiment, cryptographic operation handler 228 compares the measurements and, if they match, utilizes a previously generated key to unseal the sealed state. If they do not match, vTPM 222 prevents unsealing of the sealed state. In an alternative embodiment, vTPM 222 determines whether the measurements match by utilizing key generator 226 to generate a key from the new measurements (e.g., and vTPM state 230). Cryptographic operation handler 228 attempts to utilize the new key to unseal the sealed state. If the measurements match, the new key successfully unseals the sealed state. If the measurements do not match, the new key is unable to unseal the sealed state. In embodiments where the sealed state is successfully unsealed, cryptographic operation handler 228 provides the unsealed state to VM operating system 214, causing VM operating system 214 to relaunch VM application 234 from the sealed state. In embodiments where unsealing the sealed state is unsuccessful, cryptographic handler 228 fails to release the state to VM operating system 214, as VM operating system 214 (or another firmware or hardware to which the application state is sealed) has changed in a manner that prevents authorizing VM operating system 214 to launch VM application 234 from the sealed state.

In some embodiments, if a cryptographic operation is unsuccessful, cryptographic operation handler 228 (or another component of vTPM 222 or VM instance 208) transmits an error notification to an admin or user associated with VM instance 208 or vTPM 222. In this context, the error notification indicates the attempted request, the requesting service (e.g., the requesting application, the requesting operating system, etc.), hardware and/or software information about host computing device 200, the reason for failure (e.g., a particular measurement that did not match, an identified change in hardware, firmware, and/or software (e.g., based on mismatched measurements), etc.), a time of failure, and/or any other information with respect to the failed cryptographic operation.

Thus, several examples of utilizing an ephemeral vTPM for performing cryptographic operations have been described with respect to host computing device 200 of FIG. 2 and flowchart 400 of FIG. 4. In accordance with an embodiment, the ephemeral vTPM (e.g., vTPM 222) is used for performing cryptographic operations in “delayed key request” embodiments. In this context, a key request (or a request to utilize a key) is received at a later point in booting of VM instance 208 (e.g., after hardware (e.g., a hardware TPM) verifies guest firmware 210 and guest firmware 210 generates vTPM 222). In accordance with a non-limiting example, at this point in time VM transport interfaces are established and vTPM 222 is able to utilize the established VM transport interfaces to receive requests from subservices of VM instance 208 (e.g., guest boot manager 212, VM operating system 214, VM application 234, and/or the like). This reduces the need for a private transportation protocol to be brokered between vTPM 222 and sub-services of VM instance 208). Furthermore, in delayed key request scenarios, a key request is not required to be brokered by guest firmware 210. Instead, vTPM 222 and the sub-service of VM instance 208 communicate directly (e.g., without relying on guest firmware 210 as an intermediate).

As described elsewhere herein, vTPM 222 is also referred to as an “ephemeral” vTPM. In this context, a state of vTPM 222 (e.g., vTPM state 230) does not persist across reboots of a guest. If VM instance 208 reboots, the rebooted version of guest firmware 210 generates a new vTPM with a different state. A rebooted version of guest firmware 210 operates in various ways to generate a new vTPM, in embodiments. For instance, FIG. 5 shows a flowchart 500 of a process for generating a vTPM in a rebooted guest firmware, in accordance with an embodiment. In an embodiment, guest firmware 210 of FIG. 2 operates according to the steps of flowchart 500. Note that not all steps of flowchart 500 need be performed in all embodiments. Further structural and operational embodiments will be apparent to persons skilled in the relevant art(s) based on the following description of FIG. 5 with respect to FIG. 2.

Flowchart 500 begins with step 502. In step 502, a second state is determined based on a configuration of the guest firmware, the second state different from the first state. For example, suppose VM instance 208 is rebooted or otherwise restarted. In this context, vTPM 222, the instance of guest firmware 210, guest firmware state 246, and vTPM state 230 are “flushed” or otherwise wiped from memory of host computing device 200. In reboot/restart of VM instance 208, a new instance of guest firmware 210 (referred to herein as “new guest firmware 210”) is launched on VM instance 208 in a similar manner as described with respect to FIGS. 2 and 3. For instance, boot initializer 218 obtains guest firmware code 124 and causes state determiner 216 to determine a guest firmware state based on a configuration of new guest firmware 210. In this context, the “new” guest firmware state is different from guest firmware state 246. In accordance with an embodiment, state determiner 216 determines the new guest firmware state in a similar manner as described with respect to step 302 of flowchart 300 of FIG. 3.

In step 504, a new vTPM is generated based on the second state. For example, new guest firmware 210 generates a new instance of vTPM 222 (referred to as new vTPM 222) based on the new guest firmware state determined in step 502. In accordance with an embodiment, new guest firmware 210 generates new vTPM 222 in a similar manner as described with respect to step 304 of flowchart 300 of FIG. 3. In accordance with an embodiment, the new vTPM 222 is unable to unseal or decrypt objects bound to the original instance of vTPM 222. By binding objects to a specific instance of a vTPM, which does not persist across reboots of a guest firmware or VM instance, embodiments described herein improve security with respect to objects bound to the instance of the vTPM.

Thus, an example embodiment of generating a new instance of a vTPM based on a new state of guest firmware has been described with respect to FIG. 5. In some embodiments, a user or application desires a secret to persist across reboots of a guest firmware. In this example, the first instance of vTPM 222 utilizes a key to seal a secret (e.g., a secret protected by vTPM 222, guest firmware state 246, and/or the like). In accordance with an embodiment, the key binds the secret to a security domain other than vTPM 222 (e.g., hardware of host computing device 200, an account associated with VM instance 208, and/or the like). In an embodiment, the key binds the secret based on measurements made by vTPM 222. The sealed secret is stored in memory that persists across reboots of VM instance 208 (e.g., memory of memory device 206). In this context, once rebooted, the new instance of vTPM 222 is able to generate the key based on the same security domain and/or measurements made by the new instance of vTPM 222 and utilize the key to unseal the secret. In this context, the new instance of vTPM 222 is able to access the secret. For instance, suppose the secret was guest firmware state 246. In this context, the new instance of vTPM 222 causes guest firmware 210 to update based on guest firmware state 246. In accordance with an embodiment, in order to generate the key or to utilize the key, the new instance of vTPM 222 attests that it was generated in an isolated region of VM instance 208.

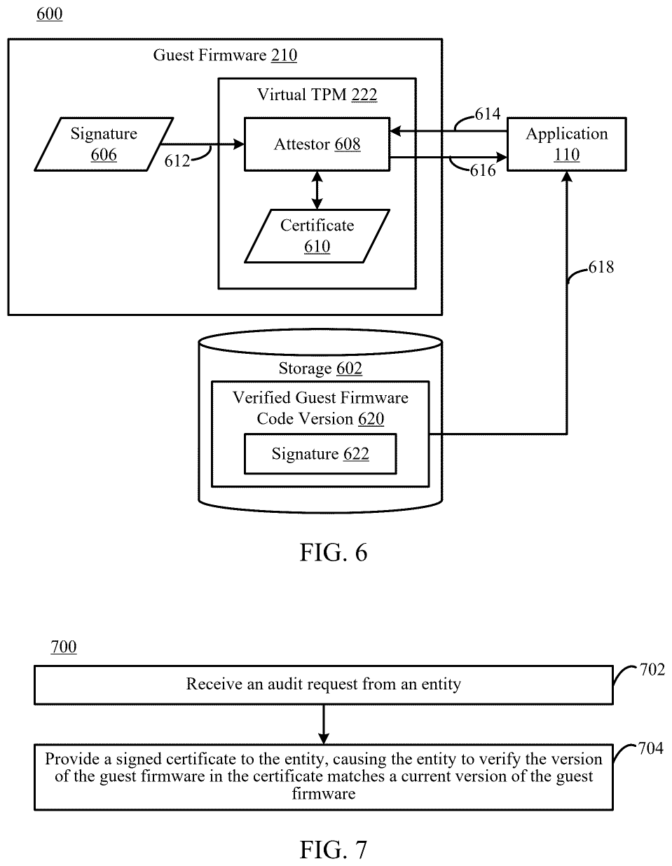

In embodiments, vTPM 222 is auditable to verify that vTPM 222 is operating correctly and to verify a trust dependency of vTPM 222. For instance, a user or application in accordance with an embodiment audits vTPM 222 to verify vTPM 222 is aligned with security policies of the user or application, or expected security policies of vTPM 222. Embodiments described herein are configured in various ways for auditing vTPM 222 and/or guest firmware 210. FIG. 6 shows a block diagram of a system 600 for auditing a guest firmware, in accordance with an embodiment. As shown in FIG. 6, system 600 comprises application 110 of computing device 102, as described with respect to system 100 of FIG. 1, guest firmware 210 of VM instance 208, as described with respect to host computing device 200 of FIG. 2, and a storage 602. As also shown in FIG. 6, guest firmware 210 comprises vTPM 222 (as described with respect to FIG. 2) and a signature 606. In FIG. 6, vTPM 222 comprises an attestor 608 and a certificate 610. Attestor 608 is a subservice of vTPM 222, in an embodiment.

In accordance with an embodiment, storage 602 is an example of storage 108, as described with respect to FIG. 1. As shown in FIG. 6, storage 602 stores a verified guest firmware code version 620 (“firmware version 620” herein). In embodiments, firmware version 620 is a particular version number of guest firmware and/or a particular configuration of guest firmware. In accordance with an embodiment, firmware version 620 is made available to computing devices, applications, and/or users for auditing whether or not firmware version 620 is compliant with security policies. For instance, in a non-limiting example, firmware version 620 is an open source code file. Alternatively, firmware version 620 is made available to customers of a (e.g., cloud or enterprise) service platform provided by a service provider (e.g., a service provider of service provider system 106). In accordance with an embodiment, and as shown in FIG. 6, firmware version 620 is signed with signature 622. Signature 622 is a digital signature of a provider of firmware version 620. For instance, in an example embodiment, firmware generator 132 of FIG. 1 generates firmware version 620 and utilizes a private signing key of service provider system 106 to sign firmware version 620 with a signature 622.

In embodiments, signature 606 and/or certificate 610 are utilized to attest authenticity of guest firmware 210 and/or vTPM 222. For instance, signature 606 is a signature of the version of guest firmware 210 and/or a configuration of guest firmware 210. In accordance with an embodiment, guest firmware 210 is signed with signature 606 by a firmware generator (e.g., firmware generator 132). In accordance with an embodiment, vTPM 222 generates certificate 610 comprising signature 606 for attestation of guest firmware 210. In embodiments, certificate 610 (or signature 606) is utilized for auditing guest firmware 210. To better understand attesting authenticity of guest firmware 210 with respect to application 110 auditing guest firmware 210, FIG. 6 is described with respect to FIG. 7. FIG. 7 shows a flowchart 700 of a process for auditing a guest firmware, in accordance with an embodiment. In an embodiment, vTPM 222 of FIG. 6 operates according to the steps of flowchart 600. Note that not all steps of flowchart 600 need be performed in all embodiments. Further structural and operational embodiments will be apparent to persons skilled in the relevant art(s) based on the following descriptions of FIGS. 6 and 7.

Flowchart 700 begins with step 702. In step 702, an audit request is received from an entity. For example, attestor 608 of FIG. 6 receives an audit request 614 from application 110. Audit request 614, in some embodiments, indicates the auditing entity (e.g., a user account, an application, a hardware system, and/or the like) (e.g., application 110 in this example).

In step 704, a signed certificate is provided to the entity, causing the entity to verify the version and/or the configuration of the guest firmware in the certificate matches a current version and/or the current configuration of the guest firmware. For example, attestor 608 of FIG. 6 receives signature 606 via signature signal 612, generates certificate 610 attesting authenticity of guest firmware 210, and provides certificate 610 to application 110 in a response 616. In accordance with an embodiment, attestor 608 identifies signature 606 by reviewing (or otherwise analyzing) code of guest firmware 210. Alternatively, signature 606 is stored in memory of guest firmware 210 or virtual TPM 222 as a certificate (e.g., certificate 610). In an embodiment, attestor 608 attests authenticity of guest firmware 210 by measuring guest firmware 210 (e.g., responsive or otherwise subsequent to receiving audit request 614) and comparing the measurements to original measurements of guest firmware 210 that vTPM 222 made (e.g., during or (e.g., immediately) subsequent to booting vTPM 222 in guest firmware 210). If the measurements match, attestor 608 generates certificate 610 comprising signature 606. In an embodiment, attestor 608 generates certificate 610 by signing signature 606 (or a file comprising signature 606) with a private signing key of vTPM 222. In embodiments, response 616 causes application 616 to verify that a version and/or a configuration of guest firmware 210 matches a firmware version 620 based on certificate 610. In an example, if application 110 determines the versions and/or configurations match, application 110 authorizes vTPM 222 for performing cryptographic operations on behalf of a user account of application 110 (e.g., of a user of computing device 102).

In an example embodiment (e.g., an open source embodiment, an embodiment that allows users to review guest firmware code, etc.), application 110 (or a user utilizing application 110) is able to review firmware version 620 to determine whether or not firmware version 620 satisfies security policies associated with (e.g., a user account of) the user. As described with respect to step 704, application 110 (or a user thereof) is able to verify, based on signed certificate 610 or signature 606, that the version and/or configuration of guest firmware 210 matches code version 620. For instance, in accordance with an embodiment, application 110 determines code version 620 is signed with the same signature as guest firmware 210 (e.g., signature 606 and signature 622 are the same signature). In accordance with an embodiment, application 110 utilizes a verification key (e.g., a public key corresponding to a private key that was utilized to generate signature 622) to verify signature 622. In this context, application 110 utilizes the same verification key to attempt to verify signature 606. If application 110 is able to verify signature 606, application 110 determines the signatures match and guest firmware 210 is verified. Otherwise, application 110 determines guest firmware 210 is different from firmware version 620, e.g., and determines not to verify firmware 210 or authorize vTPM 222 to perform cryptographic operations on behalf of a user account of application 110.

In some embodiments described herein, signature 606 is provided to application 110 for verification thereof in certificate 610. In a further embodiment, certificate 610 is signed with a private signing key of vTPM 222. In accordance with an embodiment, application 110 has access to a public verification key of vTPM 222 that corresponds to the private signing key. In this context, application 110 utilizes the public verification key to authenticate the signature of vTPM 222. If the signature is authentic, application 110 determines the certificate is genuinely generated by vTPM 222.

Thus, an example processes for auditing vTPM 222 have been described with respect to FIGS. 6 and 7. In embodiments, vTPM 222 is generated based on a state of guest firmware 210 (e.g., guest state 246) and independent of state information external to guest firmware 210. In this context, the trust dependency of vTPM 222 is limited to guest firmware 210. By limiting the trust dependencies of vTPM 222 in this manner, embodiments described herein allow entities to audit vTPM 222 in a manner that reduces compute resources and time to audit, as the auditing entity (e.g., application 110) is not required to audit a service provider or key vault external to VM instance 208 in addition to vTPM 222.

### III. Example Computer System Implementation

Embodiments of for providing vTPMs generated in isolated regions of memory herein are implemented in hardware, or hardware combined with one or both of software and/or firmware. For example application 110, VM instance 116A, VM instance 116n, guest firmware 118A, guest firmware 118n, VM operating system 120A, VM operating system 120n, vTPM 122A, vTPM 122n, guest firmware code 124, firmware generator 132, isolated region 134A, isolated region 134n, VM manager 206, VM instance 208, guest firmware 210, guest boot manager 212, VM operating system 214, state determiner 216, boot initializer 218, vTPM generator 220, vTPM 222, key generator 226, cryptographic operation handler 228, VM application 234, attestor 608, firmware version 620, and/or the components described therein, and/or the steps of flowcharts 300, 400, 500, and/or 700, are each implemented as computer program code/instructions configured to be executed in one or more processors and stored in a computer readable storage medium. Alternatively, application 110, host processing system 114A, host processing system 114n, VM instance 116A, VM instance 116n, guest firmware 118A, guest firmware 118n, VM operating system 120A, VM operating system 120n, vTPM 122A, vTPM 122n, firmware generator 132, processor 204, VM manager 206, VM instance 208, guest firmware 210, guest boot manager 212, VM operating system 214, state determiner 216, boot initializer 218, vTPM generator 220, vTPM 222, key generator 226, cryptographic operation handler 228, VM application 234, attestor 608, and/or the components described therein, and/or the steps of flowcharts 300, 400, 500, and/or 700, are implemented in one or more SoCs (system on chip). An SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

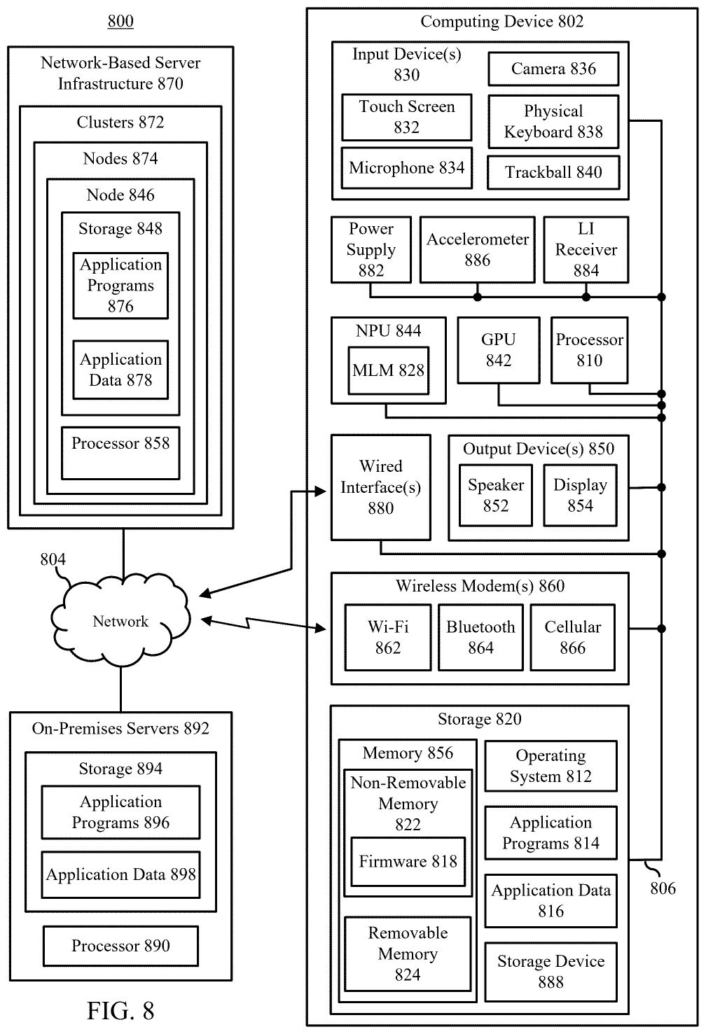

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 8. FIG. 8 shows a block diagram of an exemplary computing environment 800 that includes a computing device 802. Computing device 802 is an example of computing device 102, service provider system 106, host computing device 112A, host computing device 112n, and/or host computing device 200, which each include one or more of the components of computing device 802. In some embodiments, computing device 802 is communicatively coupled with devices (not shown in FIG. 8) external to computing environment 800 via network 804. Network 804, in an embodiment, is an example of network 130. Network 804 comprises one or more networks such as local area networks (LANs), wide area networks (WANs), enterprise networks, the Internet, etc. In examples, network 804 includes one or more wired and/or wireless portions. In some examples, network 804 additionally or alternatively includes a cellular network for cellular communications. Computing device 802 is described in detail as follows.

Computing device 802 can be any of a variety of types of computing devices. Examples of computing device 802 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 802 is a stationary computing device such as a desktop computer, a personal computer (PC), a stationary server device, a minicomputer, a mainframe, a supercomputer, etc.

As shown in FIG. 8, computing device 802 includes a variety of hardware and software components, including a processor 810, a storage 820, a graphics processing unit (GPU) 842, a neural processing unit (NPU) 844, one or more input devices 830, one or more output devices 850, one or more wireless modems 860, one or more wired interfaces 880, a power supply 882, a location information (LI) receiver 884, and an accelerometer 886. Storage 820 includes memory 856, which includes non-removable memory 822 and removable memory 824, and a storage device 888. Storage 820 also stores an operating system 812, application programs 814, and application data 816. Wireless modem(s) 860 include a Wi-Fi modem 862, a Bluetooth modem 864, and a cellular modem 866. Output device(s) 850 includes a speaker 852 and a display 854. Input device(s) 830 includes a touch screen 832, a microphone 834, a camera 836, a physical keyboard 838, and a trackball 840. Not all components of computing device 802 shown in FIG. 8 are present in all embodiments, additional components not shown may be present, and in a particular embodiment any combination of the components are present. In examples, components of computing device 802 are mounted to a circuit card (e.g., a motherboard) of computing device 802, integrated in a housing of computing device 802, or otherwise included in computing device 802. The components of computing device 802 are described as follows.

In embodiments, a single processor 810 (e.g., central processing unit (CPU), microcontroller, a microprocessor, signal processor, ASIC (application specific integrated circuit), and/or other physical hardware processor circuit) or multiple processors 810 are present in computing device 802 for performing such tasks as program execution, signal coding, data processing, input/output processing, power control, and/or other functions. In examples, processor 810 is a single-core or multi-core processor, and each processor core is single-threaded or multithreaded (to provide multiple threads of execution concurrently). Processor 810 is configured to execute program code stored in a computer readable medium, such as program code of operating system 812 and application programs 814 stored in storage 820. The program code is structured to cause processor 810 to perform operations, including the processes/methods disclosed herein. Operating system 812 controls the allocation and usage of the components of computing device 802 and provides support for one or more application programs 814 (also referred to as “applications” or “apps”). In examples, application programs 814 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 810 includes one or more general processors (e.g., CPUs) configured with or coupled to one or more hardware accelerators, such as one or more NPUs 844 and/or one or more GPUs 842.

Any component in computing device 802 can communicate with any other component according to function, although not all connections are shown for ease of illustration. For instance, as shown in FIG. 8, bus 806 is a multiple signal line communication medium (e.g., conductive traces in silicon, metal traces along a motherboard, wires, etc.) present to communicatively couple processor 810 to various other components of computing device 802, although in other embodiments, an alternative bus, further buses, and/or one or more individual signal lines is/are present to communicatively couple components. Bus 806 represents one or more of any of several types of bus structures, including a memory bus or memory controller, a peripheral bus, an accelerated graphics port, and a processor or local bus using any of a variety of bus architectures.

Storage 820 is physical storage that includes one or both of memory 856 and storage device 888, which store operating system 812, application programs 814, and application data 816 according to any distribution. Non-removable memory 822 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 822 includes main memory and is separate from or fabricated in a same integrated circuit as processor 810. As shown in FIG. 8, non-removable memory 822 stores firmware 818 that is present to provide low-level control of hardware. Examples of firmware 818 include BIOS (Basic Input/Output System, such as on personal computers) and boot firmware (e.g., on smart phones). In examples, removable memory 824 is inserted into a receptacle of or is otherwise coupled to computing device 802 and can be removed by a user from computing device 802. Removable memory 824 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 888 are present that are internal and/or external to a housing of computing device 802 and are or are not removable. Examples of storage device 888 include a hard disk drive, a SSD, a thumb drive (e.g., a USB (Universal Serial Bus) flash drive), or other physical storage device.

One or more programs are stored in storage 820. Such programs include operating system 812, one or more application programs 814, and other program modules and program data. Examples of such application programs include computer program logic (e.g., computer program code/instructions) for implementing application 110, VM instance 116A, VM instance 116n, guest firmware 118A, guest firmware 118n, VM operating system 120A, VM operating system 120n, vTPM 122A, vTPM 122n, guest firmware code 124, firmware generator 132, isolated region 134A, isolated region 134n, VM manager 206, VM instance 208, guest firmware 210, guest boot manager 212, VM operating system 214, state determiner 216, boot initializer 218, vTPM generator 220, vTPM 222, key generator 226, cryptographic operation handler 228, VM application 234, attestor 608, firmware version 620, and/or the components described therein, and/or the steps of flowcharts 300, 400, 500, and/or 700.

Storage 820 also stores data used and/or generated by operating system 812 and application programs 814 as application data 816. Examples of application data 816 include web pages, text, images, tables, sound files, video data, and other data. In examples, application data 816 is sent to and/or received from one or more network servers or other devices via one or more wired or wireless networks. Storage 820 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 802 through one or more input devices 830 and receives information from computing device 802 through one or more output devices 850. Input device(s) 830 includes one or more of touch screen 832, microphone 834, camera 836, physical keyboard 838 and/or trackball 840 and output device(s) 850 includes one or more of speaker 852 and display 854. Each of input device(s) 830 and output device(s) 850 are integral to computing device 802 (e.g., built into a housing of computing device 802) or are external to computing device 802 (e.g., communicatively coupled wired or wirelessly to computing device 802 via wired interface(s) 880 and/or wireless modem(s) 860). Further input devices 830 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 854 displays information, as well as operating as touch screen 832 by receiving user commands and/or other information (e.g., by touch, finger gestures, virtual keyboard, etc.) as a user interface. Any number of each type of input device(s) 830 and output device(s) 850 are present, including multiple microphones 834, multiple cameras 836, multiple speakers 852, and/or multiple displays 854.

In embodiments where GPU 842 is present, GPU 842 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 842 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 844 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 828. In an example, NPU 844 is configured for a data-driven parallel computing and is highly efficient at processing massive multimedia data such as videos and images and processing data for neural networks. NPU 844 is configured for efficient handling of AI-related tasks, such as speech recognition, background blurring in video calls, photo or video editing processes like object detection, etc.

In embodiments disclosed herein that implement ML models, NPU 844 can be utilized to execute such ML models, of which MLM 828 is an example. For instance, where applicable, MLM 828 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 844 is used to train MLM 828. To train MLM 828, training data is that includes input features (attributes) and their corresponding output labels/target values (e.g., for supervised learning) is collected. A training algorithm is a computational procedure that is used so that MLM 828 learns from the training data. Parameters/weights are internal settings of MLM 828 that are adjusted during training by the training algorithm to reduce a difference between predictions by MLM 828 and actual outcomes (e.g., output labels). In some examples, MLM 828 is set with initial values for the parameters/weights. A loss function measures a dissimilarity between predictions by MLM 828 and the target values, and the parameters/weights of MLM 828 are adjusted to minimize the loss function. The parameters/weights are iteratively adjusted by an optimization technique, such as gradient descent. In this manner, MLM 828 is generated through training by NPU 844 to be used to generate inferences based on received input feature sets for particular applications. MLM 828 is generated as a computer program or other type of algorithm configured to generate an output (e.g., a classification, a prediction/inference) based on received input features, and is stored in the form of a file or other data structure.

In examples, such training of MLM 828 by NPU 844 is supervised or unsupervised. According to supervised learning, input objects (e.g., a vector of predictor variables) and a desired output value (e.g., a human-labeled supervisory signal) train MLM 828. The training data is processed, building a function that maps new data on expected output values. Example algorithms usable by NPU 844 to perform supervised training of MLM 828 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 828 is an LLM, MLM 828 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user's ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 828 is trained to learn patterns from unlabeled data. For instance, in embodiments where MLM 828 implements unsupervised learning techniques, MLM 828 identifies one or more classifications or clusters to which an input belongs. During a training phase of MLM 828 according to unsupervised learning, MLM 828 tries to mimic the provided training data and uses the error in its mimicked output to correct itself (i.e., correct weights and biases). In further examples, NPU 844 perform unsupervised training of MLM 828 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 844 need not necessarily be present in all ML model embodiments. In embodiments where ML models are present, any one or more of processor 810, GPU 842, and/or NPU 844 can be present to train and/or execute MLM 828.

One or more wireless modems 860 can be coupled to antenna(s) (not shown) of computing device 802 and can support two-way communications between processor 810 and devices external to computing device 802 through network 804, as would be understood to persons skilled in the relevant art(s). Wireless modem 860 is shown generically and can include a cellular modem 866 for communicating with one or more cellular networks, such as a GSM network for data and voice communications within a single cellular network, between cellular networks, or between the mobile device and a public switched telephone network (PSTN). In examples, wireless modem 860 also or alternatively includes other radio-based modem types, such as a Bluetooth modem 864 (also referred to as a “Bluetooth device”) and/or Wi-Fi modem 862 (also referred to as an “wireless adaptor”). Wi-Fi modem 862 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 864 is configured to communicate with another Bluetooth-capable device according to the Bluetooth short-range wireless technology standard(s) such as IEEE 802.8.1 and/or managed by the Bluetooth Special Interest Group (SIG).

Computing device 802 can further include power supply 882, LI receiver 884, accelerometer 886, and/or one or more wired interfaces 880. Example wired interfaces 880 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 880 of computing device 802 provide for wired connections between computing device 802 and network 804, or between computing device 802 and one or more devices/peripherals when such devices/peripherals are external to computing device 802 (e.g., a pointing device, display 854, speaker 852, camera 836, physical keyboard 838, etc.). Power supply 882 is configured to supply power to each of the components of computing device 802 and receives power from a battery internal to computing device 802, and/or from a power cord plugged into a power port of computing device 802 (e.g., a USB port, an A/C power port). LI receiver 884 is useable for location determination of computing device 802 and in examples includes a satellite navigation receiver such as a Global Positioning System (GPS) receiver and/or includes other type of location determiner configured to determine location of computing device 802 based on received information (e.g., using cell tower triangulation, etc.). Accelerometer 886, when present, is configured to determine an orientation of computing device 802.

Note that the illustrated components of computing device 802 are not required or all-inclusive, and fewer or greater numbers of components can be present as would be recognized by one skilled in the art. In examples, computing device 802 includes one or more of a gyroscope, barometer, proximity sensor, ambient light sensor, digital compass, etc. In an example, processor 810 and memory 856 are co-located in a same semiconductor device package, such as being included together in an integrated circuit chip, FPGA, or system-on-chip (SOC), optionally along with further components of computing device 802.

In embodiments, computing device 802 is configured to implement any of the above-described features of flowcharts herein. Computer program logic for performing any of the operations, steps, and/or functions described herein is stored in storage 820 and executed by processor 810.

In some embodiments, server infrastructure 870 is present in computing environment 800 and is communicatively coupled with computing device 802 via network 804. Server infrastructure 870, when present, is a network-accessible server set (e.g., a cloud-based environment or platform). As shown in FIG. 8, server infrastructure 870 includes clusters 872. Each of clusters 872 comprises a group of one or more compute nodes and/or a group of one or more storage nodes. For example, as shown in FIG. 8, cluster 872 includes nodes 874. Each of nodes 874 are accessible via network 804 (e.g., in a “cloud-based” embodiment) to build, deploy, and manage applications and services. In examples, any of nodes 874 is a storage node that comprises a plurality of physical storage disks, SSDs, and/or other physical storage devices that are accessible via network 804 and are configured to store data associated with the applications and services managed by nodes 874.

Each of nodes 874, as a compute node, comprises one or more server computers, server systems, and/or computing devices. For instance, a node 874 in accordance with an embodiment includes one or more of the components of computing device 802 disclosed herein. Each of nodes 874 is configured to execute one or more software applications (or “applications”) and/or services and/or manage hardware resources (e.g., processors, memory, etc.), which are utilized by users (e.g., customers) of the network-accessible server set. In examples, as shown in FIG. 8, nodes 874 includes a node 846 that includes storage 848 and/or one or more of a processor 858 (e.g., similar to processor 810, GPU 842, and/or NPU 844 of computing device 802). Storage 848 stores application programs 876 and application data 878. Processor(s) 858 operate application programs 876 which access and/or generate related application data 878. In an implementation, nodes such as node 846 of nodes 874 operate or comprise one or more virtual machines, with each virtual machine emulating a system architecture (e.g., an operating system), in an isolated manner, upon which applications such as application programs 876 are executed.

In embodiments, one or more of clusters 872 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 872 are included in a datacenter in a distributed collection of datacenters. In embodiments, exemplary computing environment 800 comprises part of a cloud-based platform.

In an embodiment, computing device 802 accesses application programs 876 for execution in any manner, such as by a client application and/or a browser at computing device 802.

In an example, for purposes of network (e.g., cloud) backup and data security, computing device 802 additionally and/or alternatively synchronizes copies of application programs 814 and/or application data 816 to be stored at network-based server infrastructure 870 as application programs 876 and/or application data 878. In examples, operating system 812 and/or application programs 814 include a file hosting service client configured to synchronize applications and/or data stored in storage 820 at network-based server infrastructure 870.

In some embodiments, on-premises servers 892 are present in computing environment 800 and are communicatively coupled with computing device 802 via network 804. On-premises servers 892, when present, are hosted within an organization's infrastructure and, in many cases, physically onsite of a facility of that organization. On-premises servers 892 are controlled, administered, and maintained by IT (Information Technology) personnel of the organization or an IT partner to the organization. Application data 898 can be shared by on-premises servers 892 between computing devices of the organization, including computing device 802 (when part of an organization) through a local network of the organization, and/or through further networks accessible to the organization (including the Internet). Furthermore, in examples, on-premises servers 892 serve applications such as application programs 896 to the computing devices of the organization, including computing device 802. Accordingly, in examples, on-premises servers 892 include storage 894 (which includes one or more physical storage devices such as storage disks and/or SSDs) for storage of application programs 896 and application data 898 and include a processor 890 (e.g., similar to processor 810, GPU 842, and/or NPU 844 of computing device 802) for execution of application programs 896. In some embodiments, multiple processors 890 are present for execution of application programs 896 and/or for other purposes. In further examples, computing device 802 is configured to synchronize copies of application programs 814 and/or application data 816 for backup storage at on-premises servers 892 as application programs 896 and/or application data 898.

Embodiments described herein may be implemented in one or more of computing device 802, network-based server infrastructure 870, and on-premises servers 892. For example, in some embodiments, computing device 802 is used to implement systems, clients, or devices, or components/subcomponents thereof, disclosed elsewhere herein. In other embodiments, a combination of computing device 802, network-based server infrastructure 870, and/or on-premises servers 892 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 820. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 814) are stored in storage 820. Such computer programs can also be received via wired interface(s) 860 and/or wireless modem(s) 860 over network 804. Such computer programs, when executed or loaded by an application, enable computing device 802 to implement features of embodiments discussed herein. Accordingly, such computer programs represent controllers of the computing device 802.

Embodiments are also directed to computer program products comprising computer code or instructions stored on any computer-readable medium or computer-readable storage medium. Such computer program products include the physical storage of storage 820 as well as further physical storage types.

### IV. Additional Exemplary Embodiments

A system is described herein. The system comprises a processor and memory. The memory comprises program code executable by the processor. The program code comprises a guest firmware. The guest firmware is structured to cause the processor to: determine a first state based on a configuration of the guest firmware, generate a virtual trusted platform module (vTPM) based on the first state in an isolated region of the memory associated with a virtual machine that prevents unauthorized access to the first state, and cause the vTPM to perform a cryptographic operation, resulting in a cryptographic result.

In accordance with an embodiment of the foregoing system, the guest firmware utilizes the vTPM to perform the cryptographic operation.

In accordance with an embodiment of the foregoing system, the guest firmware causes a boot manager of a virtual machine, an application of the virtual machine, or a unified extensible firmware interface to utilize the vTPM to perform the cryptographic operation.

In accordance with an embodiment of the foregoing system, the vTPM is generated in an isolated region of the memory.

In a further embodiment of the foregoing system, the cryptographic result is provided to a virtual machine.

In a further embodiment of the foregoing system, the guest firmware is guest firmware of the virtual machine.

In a further embodiment of the foregoing system, the cryptographic result is stored in memory accessible to the vTPM.

In a further embodiment of the foregoing system, the guest firmware is structured to cause the vTPM to unseal a sealed state of an operating system of a virtual machine, resulting in an unsealed state of the operating system, and cause the operating system to boot based on the unsealed state.

In a further embodiment of the foregoing system, the guest firmware is structured to cause the vTPM to perform the cryptographic operation by: receiving, by the vTPM and from an application executing on the virtual machine, a request to perform the cryptographic operation; and utilizing, by the vTPM, a key to perform the cryptographic operation, resulting in the cryptographic result.

In a further embodiment of the foregoing system, the cryptographic operation on behalf of the application comprises one or more of: decrypting an object, encrypting an object, releasing an object to the application, sealing an object to the application and the vTPM, unsealing an object that is sealed to the application, verifying a signature, signing an object, verifying a measurement, or caching data on behalf of the application.

In a further embodiment of the foregoing system, the guest firmware is structured to cause the vTPM to perform the cryptographic operation by: receiving, by the vTPM and from an operating system of the virtual machine, a request to perform the cryptographic operation; and utilizing, by the vTPM, a key to perform the cryptographic operation, resulting in the cryptographic result.

In a further embodiment of the foregoing system, the cryptographic operation on behalf of the operating system comprises one or more of: decrypting an object, encrypting an object, releasing an object to the VM operating system, sealing an object to the VM operating system and the vTPM, unsealing an object that is sealed to the VM operating signature, verifying a signature, signing an object, verifying a measurement, or caching data on behalf of the VM operating system.

In a further embodiment of the foregoing system, the object is a sealed or unsealed state of a VM application hosted by the VM operating system.

In a further embodiment of the foregoing system, the guest firmware is structured to cause the processor to determine the first state independent of state information external to the guest firmware.

In a further embodiment of the foregoing system, the vTPM comprises a signed certificate attesting to a version and/or a configuration of the guest firmware and the vTPM.

In a further embodiment of the foregoing system, vTPM receives an audit request from an entity and provides the signed certificate to the entity, causing the entity to verify the version and/or the configuration of the guest firmware in the certificate matches a current version and/or configuration of the guest firmware.

In a further embodiment of the foregoing system, to determine the first state, the guest firmware is structured to cause the processor to generate the first state at runtime of the guest firmware.

In a further embodiment of the foregoing system, the guest firmware is structured to cause the processor to, subsequent to a reboot of the guest firmware: determine a second state based on a configuration of the guest firmware, the second state different from the first state; and generate a new vTPM based on the second state.

In a further embodiment of the foregoing system, the virtual machine is a confidential virtual machine and the guest firmware is guest firmware of the confidential virtual machine.

A method is described herein. The method is performed by a guest firmware of a virtual machine executing on a computing device. The method comprises: determining a first state based on a configuration of the guest firmware; generating, in an isolated region of memory associated with the virtual machine, a virtual trusted platform module (vTPM) based on the first state, the isolated region preventing unauthorized access to the first state; causing the vTPM to perform a cryptographic operation, resulting in a cryptographic result.

In accordance with an embodiment of the foregoing method, the guest firmware utilizes the vTPM to perform the cryptographic operation.

In accordance with an embodiment of the foregoing method, the guest firmware causes a boot manager of a virtual machine, an application of the virtual machine, or a unified extensible firmware interface to utilize the vTPM to perform the cryptographic operation.

In accordance with an embodiment of the foregoing method, the vTPM is generated in an isolated region of memory of the computing device.

In a further embodiment of the foregoing method, the cryptographic result is provided to a virtual machine.

In a further embodiment of the foregoing method, the guest firmware is guest firmware of the virtual machine.

In a further embodiment of the foregoing method, the cryptographic result is stored in memory accessible to the vTPM.

In a further embodiment of the foregoing method, the cryptographic operation comprises unsealing a sealed state of an operating system of the virtual machine. The cryptographic result is an unsealed state of the operating system. Said providing the cryptographic result to the virtual machine comprises: causing the operating system to boot based on the unsealed state.

In a further embodiment of the foregoing method, said causing the vTPM to perform a cryptographic operation comprises: receiving, by the vTPM and from an application executing on the virtual machine, a request to perform the cryptographic operation; and utilizing, by the vTPM, a key to perform the cryptographic operation, resulting in the cryptographic result.

In a further embodiment of the foregoing method, the cryptographic operation on behalf of the application comprises one or more of: decrypting an object, encrypting an object, releasing an object to the application, sealing an object to the application and the vTPM, unsealing an object that is sealed to the application, verifying a signature, signing an object, verifying a measurement, or caching data on behalf of the application.

In a further embodiment of the foregoing method, said causing the vTPM to perform a cryptographic operation comprises: receiving, by the vTPM and from an operating system of the virtual machine, a request to perform the cryptographic operation; and utilizing, by the vTPM, a key to perform the cryptographic operation, resulting in the cryptographic result.

In a further embodiment of the foregoing method, the cryptographic operation on behalf of the operating system comprises one or more of: decrypting an object, encrypting an object, releasing an object to the VM operating system, sealing an object to the VM operating system and the vTPM, unsealing an object that is sealed to the VM operating signature, verifying a signature, signing an object, verifying a measurement, or caching data on behalf of the VM operating system.

In a further embodiment of the foregoing method, said determining the first state comprises: determining the first state independent of state information external to the guest firmware.

In a further embodiment of the foregoing method, the vTPM comprises a signed certificate attesting to a version and/or configuration of the guest firmware and the vTPM.

In a further embodiment of the foregoing method, the method further comprises: receiving an audit request from an entity; and providing the signed certificate to the entity, causing the entity to verify the version and/or configuration of the guest firmware in the certificate matches a current version and/or configuration of the guest firmware.

In a further embodiment of the foregoing method, said determining the first state comprises: generating the first state at runtime of the guest firmware.

In a further embodiment of the foregoing method, the method further comprises: subsequent to a reboot of the guest firmware, determining a second state based on a configuration of the guest firmware, the second state different from the first state; and generating a new vTPM based on the second state.

In a further embodiment of the foregoing method, the virtual machine is a confidential virtual machine and the guest firmware is guest firmware of the confidential virtual machine.

A computer-readable storage medium encoded with program instructions is described herein. The program instructions comprise guest firmware. The guest firmware is structured to cause a processor circuit to perform any of the foregoing methods.

### V. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Further still, several example embodiments have been shown and described with respect to generating a (e.g., ephemeral) vTPM in a guest firmware of a VM instance. However, as also described herein, embodiments described herein are not so limited. For instance, any of the examples described herein can be modified such that the vTPM is generated in an isolated region of the VM instance other than the guest firmware. For example, a vTPM can be generated in an isolated portion of a guest boot manager or an isolated region of memory for hosting a vTPM.

Moreover, according to the described embodiments and techniques, any components of systems, computing devices, service provider systems, host computing devices, vTPMs, VM instances, guest firmware, and/or processing systems and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A system comprising:
a processor; and
memory comprising program code executable by the processor, the program code comprising a guest firmware of a virtual machine, the guest firmware structured to cause the processor to:
determine a first state based on a configuration of the guest firmware,
generate, in an isolated region of the memory associated with the virtual machine, a virtual trusted platform module (vTPM) based on the first state, the isolated region preventing unauthorized access to the first state,
cause the vTPM to unseal a sealed state of an operating system of the virtual machine, resulting in an unsealed state of the operating system; and
cause the operating system to boot based on the unsealed state.

2. The system of claim 1, wherein the guest firmware is structured to cause the processor to determine the first state independent of state information external to the guest firmware.

3. The system of claim 1, wherein the vTPM comprises a signed certificate attesting to a version of the guest firmware and the vTPM.

4. The system of claim 3, wherein the vTPM
receives an audit request from an entity; and
provides the signed certificate to the entity, causing the entity to verify the version of the guest firmware in the certificate matches a current version of the guest firmware.

5. The system of claim 1, wherein to determine the first state, the guest firmware is structured to cause the processor to generate the first state at runtime of the guest firmware.

6. The system of claim 1, wherein the guest firmware is structured to cause the processor to, subsequent to a reboot of the guest firmware:
determine a second state based on a configuration of the guest firmware, the second state different from the first state; and
generate a new vTPM based on the second state.

7. The system of claim 1, wherein the virtual machine is a confidential virtual machine and the guest firmware is guest firmware of the confidential virtual machine.

8. A method performed by a guest firmware of a virtual machine executing on a computing device, the method comprising:
determining a first state based on a configuration of the guest firmware;
generating, in an isolated region of memory associated with the virtual machine, a virtual trusted platform module (vTPM) based on the first state, the isolated region preventing unauthorized access to the first state;
causing the vTPM to perform a cryptographic operation, resulting in a cryptographic result; and
providing the cryptographic result to the virtual machine.

9. The method of claim 8, wherein:
the cryptographic operation comprises unsealing a sealed state of an operating system of the virtual machine;
the cryptographic result is an unsealed state of the operating system; and
said providing the cryptographic result to the virtual machine comprises:
causing the operating system to boot based on the unsealed state.

10. The method of claim 8, wherein said causing the vTPM to perform a cryptographic operation comprises:
receiving, by the vTPM and from an application executing on the virtual machine, a request to perform the cryptographic operation; and
utilizing, by the vTPM, a key to perform the cryptographic operation, resulting in the cryptographic result.

11. The method of claim 8, wherein said determining the first state comprises:
determining the first state independent of state information external to the guest firmware.

12. The method of claim 8, wherein the vTPM comprises a signed certificate attesting to a version of the guest firmware and the vTPM.

13. The method of claim 12, further comprising:
receiving an audit request from an entity; and
providing the signed certificate to the entity, causing the entity to verify the version of the guest firmware in the certificate matches a current version of the guest firmware.

14. The method of claim 8, wherein said determining the first state comprises:
generating the first state at runtime of the guest firmware.

15. The method of claim 8, further comprising:
subsequent to a reboot of the guest firmware, determining a second state based on a configuration of the guest firmware, the second state different from the first state; and
generating a new vTPM based on the second state.

16. A computer-readable storage medium encoded with program instructions comprising guest firmware, the guest firmware of a virtual machine structured to cause a processor circuit to perform a method comprising:
determining a first state based on a configuration of the guest firmware;
generating, in an isolated region of the memory associated with the virtual machine, a virtual trusted platform module (vTPM) based on the first state, the isolated region preventing unauthorized access to the first state;
causing the vTPM to perform a cryptographic operation, resulting in a cryptographic result; and
providing the cryptographic result to the virtual machine.

17. The computer-readable storage medium of claim 16, wherein:
the cryptographic operation comprises unsealing a sealed state of an operating system of the virtual machine;
the cryptographic result is an unsealed state of the operating system; and
said providing the cryptographic result to the virtual machine comprises:
causing the operating system to boot based on the unsealed state.

18. The computer-readable storage medium of claim 16, wherein said causing the vTPM to perform a cryptographic operation comprises:
receiving, by the vTPM and from an application executing on the virtual machine, a request to perform the cryptographic operation; and
utilizing, by the vTPM, a key to perform the cryptographic operation, resulting in the cryptographic result.

19. The computer-readable storage medium of claim 16, wherein said determining the first state comprises:
determining the first state independent of state information external to the guest firmware.

20. The computer-readable storage medium of claim 16, wherein the vTPM comprises a signed certificate attesting to a version of the guest firmware and the vTPM, and the method further comprises:
receiving an audit request from an entity; and
providing the signed certificate to the entity, causing the entity to verify the version of the guest firmware in the certificate matches a current version of the guest firmware.
